(19) United States
(12) Patent Application Publication
(10) Pub. No.: US 2003/0041659 A1
(43) Pub. Date: Mar. 6, 2003

(54) Electrically conductive engine oil pan sensor mounting arrangement

(75) Inventors: Gary Allen Marszalek, South Lyon, MI (US); Anthony Joseph Ruggirello, Chesterfield Township, MI (US)

Correspondence Address: Bill C. Panagos, Detroit Diesel Corportation, 13400 Outer Drive, West, Detroit, MI, 48239-4001, US

(73) Assignee: Detroit Diesel Corporation

(21) Appl. No.: 09/945,529

(22) Filed: Sep. 4, 2001

(51) Int. Cl. G01M 15/00

(52) U.S. Cl. 73/119 R

(57) ABSTRACT

An engine oil pan of the electrically conductive type in which a case grounded sensor can be mounted in a wall of the pan and in which the oil pan is grounded to one circuit and the sensor is connected to another circuit includes an insulating bushing disposed between the oil pan and case grounded sensor for electrically isolating the oil pan and sensor circuits from each other.

### TECHNICAL FIELD

The invention relates to internal combustion engines and more particularly to the mounting of a case grounded oil condition sensor in an electrically conductive engine oil pan.

### BACKGROUND OF THE INVENTION

An engine used in a vehicle application typically includes an oil pan mounted underneath the engine. The oil pan acts as a sump for oil circulated while the engine is running.

Often these oil pans are made of an electrically conductive material such as steel or aluminum and the pan is grounded in an electrical circuit of the vehicle.

Oil condition case grounded sensors have been developed that sense certain characteristics or a quality of the engine oil when exposed to the oil. These sensors require electrical connectivity in order to be operated and provide accurate readings, which can be relied upon and interpreted by processing equipment or visually read.

When installed in an electrically conductive oil pan that is subject to a charge, these case grounded sensors tend to short and/or take on a DC bias that causes the sensor to foul and not operate properly.

### SUMMARY OF THE INVENTION

The present invention provides a mounting arrangement for a case grounded oil condition sensor that avoids that shorting and DC bias problems associated with mounting the case grounded sensor in an electrically conductive oil pan and allows the sensor to operate according to its specifications.

More specifically the present invention provides an improvement in an engine oil pan of the electrically conductive type in which a case grounded sensor is mounted in a wall of the pan and in which the oil pan is grounded to one circuit and the sensor is grounded to another circuit by disposing an insulating bushing between the oil pan and case grounded sensor for electrically isolating the circuits from each other.

In one embodiment the bushing is made of a high temperature and oil resistant material. Preferably, the bushing is made of a plastic or rubber material into a tubular shape, which is threaded or permanently disposed in a wall of the oil pan.

A method for mounting a case grounded sensor in a wall of an engine oil pan of the electrically conductive type wherein the oil pan is grounded to one circuit and the sensor is grounded to another circuit includes disposing an insulating bushing between the oil pan and case grounded sensor for electrically isolating the oil pan and sensor circuits from each other.

An oil quality sensing system includes in combination an electrically conductive engine oil pan grounded to one circuit, a case grounded oil quality sensor grounded to another circuit; and an insulating bushing disposed between the oil pan and case grounded sensor for electrically isolating the circuits from each other.

These and other features and advantages of the invention will be more fully understood from the following description of certain specific embodiments of the invention taken together with the accompanying drawings.

### BRIEF DESCRIPTION OF THE DRAWINGS

In the drawings:

FIG. 1 is a perspective view of an engine oil pan, case grounded oil quality sensor mounting arrangement in accordance with the present invention;

FIG. 2 is an interior plan view of the engine oil pan of FIG. 1 illustrating a sensor insulator or bushing and case grounded sensor mounted in a side wall of the oil pan; and

FIG. 3 is a perspective view of the sensor insulator in accordance with one embodiment of the invention.

### DESCRIPTION OF THE PREFERRED EMBODIMENT

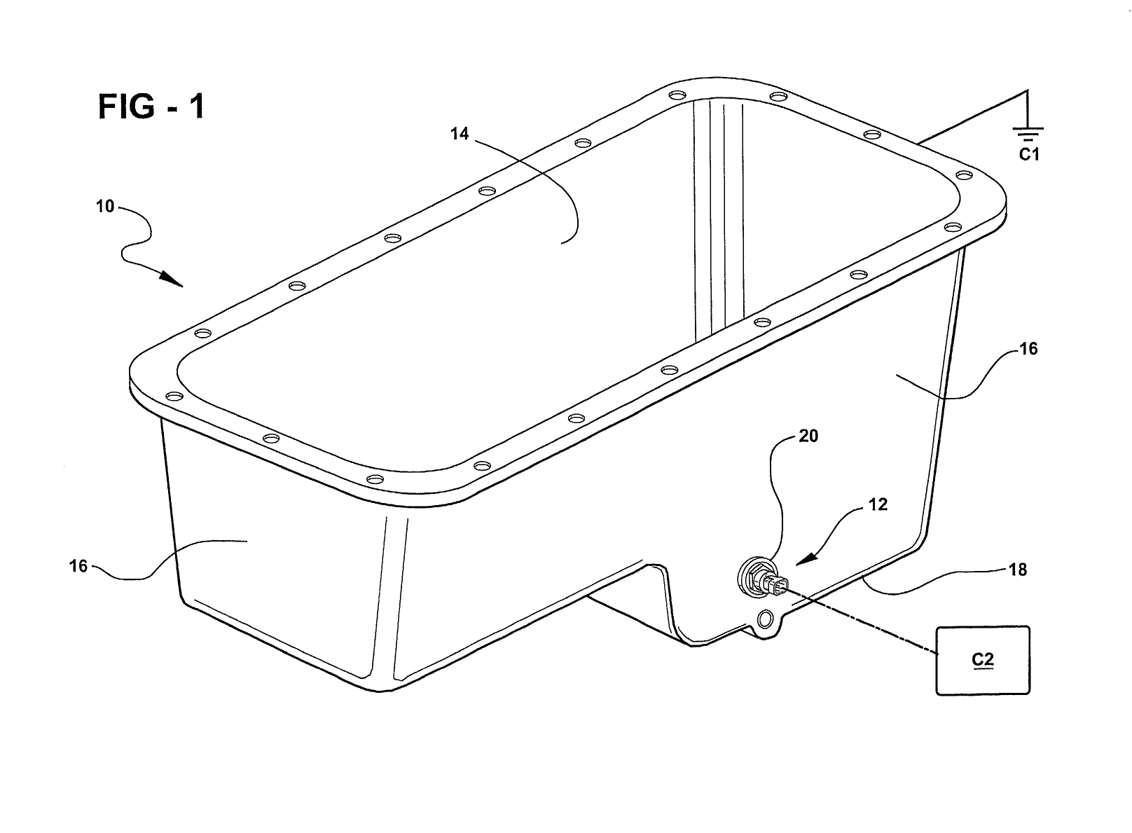

Referring to FIG. 1 of the drawings, an engine oil pan assembly in accordance with the present invention is generally indicated by reference numeral 10 and is used to mount a case grounded oil condition sensor 12 therein. As is hereinafter more fully described, the engine oil pan assembly 10 provides an electrically insulated mount for the case mounted oil conditioning sensor 12, isolating a circuit in which the pan is grounded, from another circuit in which the case mounted sensor is electrically connected.

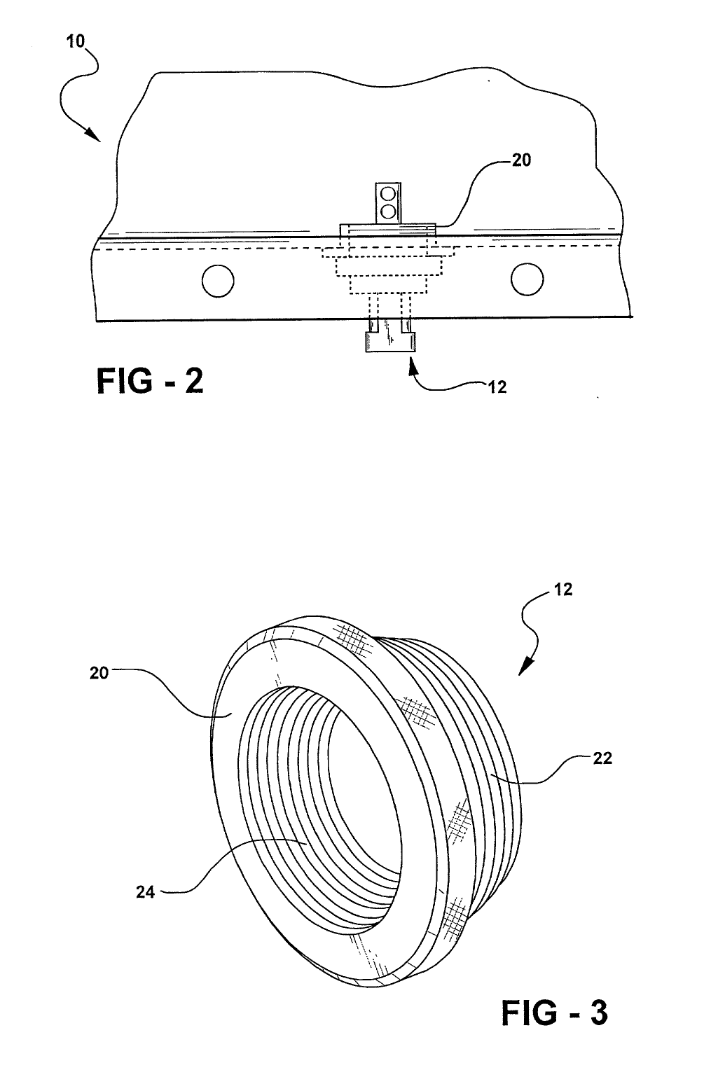

As shown in FIGS. 1 and 2 the engine oil pan assembly 10 includes an electrically conductive oil pan 14 made of metal material, such as aluminum or steel having sidewalls 16 and a bottom wall 18 as is generally known. An electrically insulating bushing 20, illustrated in detail in FIG. 3, is mounted in a sidewall 16 of the oil pan 14. The oil condition sensor 12 is received in the insulating bushing 20 in an advantageous manner to contact oil in the pan. Although sensor 12 is mounted in the oil pan 14, it is electrically isolated from the pan and unaffected by any charge that may exist in the pan.

With further reference to FIG. 3, in one embodiment of the invention, the bushing 20 includes threaded outside and inside diameters 22, 24 respectively, to allow easy threaded assembly of the bushing in the oil pan 14 and easy threaded assembly of the sensor 12 in the bushing. The threaded inside diameter 24 also allows the sensor 12 to be mounted to allow maximum penetration through the side wall 16.

In a preferable embodiment of the invention, the bushing 20 is made of a high heat resistant and oil resistance plastics or rubber material. Use of materials such NYLATRON™ and DELRON™ of the DuPont Company are successfully employed.

In use, the engine oil pan assembly 12 is mounted under an engine block (not shown) and provides a reservoir for oil circulated when the engine is run. In a vehicle application, such an engine is subject to a charge associated with a vehicle electrical system and the engine and pan will be grounded to a circuit C1. The oil conditioning sensor 12 requires its own electrical conductivity and forms part of another circuit C2. Oil sensor 12 is designed to be in contact with the circulating engine oil and sense predetermined characteristics of the oil quality.

Because insulating bushing 20 is disposed between the oil pan wall 16 and case mounted sensor 12, the pan circuit C1 is isolated from the sensor circuit C2 and the sensor is allowed to operate properly.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. In an engine oil pan of the electrically conductive type in which a case grounded sensor is mounted in a wall of said pan and in which the oil pan is grounded to one circuit and the sensor is grounded to another circuit, the improvement comprising:
an insulating bushing disposed between said oil pan and case grounded sensor for electrically isolating said circuits from each other.

2. The improvement of claim 1 wherein said bushing is made of a high temperature resistant material.

3. The improvement of claim 1 wherein said bushing is made of an oil resistant material.

4. The improvement of claim 1 wherein said bushing comprises one of a plastics or rubber material.

5. The improvement of claim 1 wherein said bushing is of a tubular shape having threaded inside and outside diameters.

6. In a method for mounting a case grounded sensor in a wall of an engine oil pan of the electrically conductive type wherein the oil pan is grounded to one circuit and the sensor is grounded to another circuit, the improvement comprising:
disposing an insulating bushing between said oil pan and case grounded sensor for electrically isolating said circuits from each other.

7. An oil quality sensing system comprising in combination:
an electrically conductive engine oil pan grounded to one circuit, a case grounded oil quality sensor grounded to another circuit; and an insulating bushing disposed between said oil pan and case grounded sensor for electrically isolating said circuits from each other.
